(19) United States
(12) Patent Application Publication
(10) Pub. No.: US 2026/0357872 A1
(43) Pub. Date: Nov. 12, 2026

(54) Securing Assembly

(71) Applicants: Aldrich Meyer, Alberton (ZA); Paul Michael Davis, Johannesburg (ZA)

(72) Inventor: Aldrich Meyer, Alberton (ZA)

(73) Assignees: Alrich Meyer, Alberton (ZA); Paul Michael Davis, Johannesburg (ZA)

(21) Appl. No.: 19/120,930

(22) PCT Filed: Sep. 29, 2023
(86) PCT No.: PCT/ZA2023/050061

§ 371 Date: Apr. 14, 2025

(30) Foreign Application Priority Data
Oct. 14, 2022 (ZA) 202211279

(51) Int. Cl. F16G 11/10; F16G 11/14

(52) U.S. Cl. CPC F16G 11/103; F16G 11/146

(57) ABSTRACT

The invention provides a securing assembly which includes an elongate flexible member which extends between a free end and a stop end; a clamp head which has a body which includes a clamping surface, an opposed securing surface, an edge along which the clamping and the securing surfaces meet, and an aperture through which the flexible member twice passes to provide, on opposed sides of the body, a securing loop and a free end section respectively; and a clamping formation on the flexible member between the clamp body and the stop end that is adapted to clamp the free end section of the flexible member between it and the clamping surface when the free end section is pulled, drawing the clamping formation into engagement with the clamp body.

### FIELD OF THE INVENTION

This invention pertains to a securing assembly which offers a means for joining different sections of a cord without requiring the use of a knot.

### BACKGROUND OF THE INVENTION

Securing items with a length of cord (twine, string or the like) is dependent on the ability to tie or secure the loose ends of the twine once the twine has been wound around the item.

In the absence of mechanically complicated or expensive attachment devices that either come with the twine or require separate purchase and supply, the twine will need to be tied.

Without specialist knowledge on the best way to tie ends of the twine together, more often than not, the choice of knot is insufficient to carry the load of the item resulting in the knot unravelling.

The invention aims to address the aforementioned problem at least partially.

### SUMMARY OF INVENTION

The invention provides a securing assembly which includes:
an elongate flexible member which extends between a first (free) end and a second (stop) end,
a clamp head which has a body which includes a clamping surface and, on an opposed side, a securing surface, and an aperture which extends through the body between the clamping surface and the securing surface, and
a clamping element,
wherein the flexible member engages the body by passage through the aperture to provide a loop on a side of the securing surface, with the first and second ends on a side of the clamping surface, and
wherein the clamping element engages the flexible member between the clamping surface and the second end, in a position to clamp a first end section of the flexible member between it and the clamping surface when the free end section is pulled to draw the clamping element into engagement with the clamp body.

The invention further provides a securing assembly kit which includes:
an elongate flexible member which extends between a first end and a second end,
a clamp head which has a body which includes a clamping surface, a securing surface, an edge along which the clamping and the securing surfaces meet, and an aperture between the clamping surface and the securing surface which is adapted to receive passage of the elongate flexible member, and
a clamping element which is adapted to engage the elongate flexible member.

The statements that follow are in respect of both preceding aspects of the invention.

The clamping and the securing surfaces may meet an edge.

The body may be substantially planar.

The body comprises a core and a plurality of anti-rotation projections emanating from the core within a common plane, each configured to prevent rotation of the body when the elongated flexible member experiences tension.

The core may be polygonal, either triangular, quadrilateral, octagonal, or the like, or circular in shape.

The body may include at least one positioning formation on the clamping surface, which formation is adapted to position the clamping element, preventing the clamping element from engaging the clamp head non-concentrically.

The at least one position formation may be a recess formed in the clamping surface, concentric with the aperture and adapted to receive the clamping element.

Alternatively, the body includes a plurality of positioning formations.

Each of the positioning formations may be elevated from the clamping surface, either as a ridge at an edge of each anti-rotation projection, or as projection or button.

The body may include at least one gripping ridge which is elevated from the clamping surface, and which is concentric with the aperture.

The at least one gripping ridge may present an upper surface. The upper surface may be serrated.

The securing surface may be chamfered around the aperture to provide a chamfered recess, configured to receive an inter-twined portion of the elongate element in snap fit.

The clamping formation may be a disc, washer or the like which has a hole which is sized to receive passage of the elongate element.

The elongate element may have a stop formation positioned at or proximate to the second end

The stop formation may include a knot in the elongate element and a cone-shaped hollow element on the elongate element into which the knot engages.

The invention extends to a clamping device for use in a securing assembly comprising a clamp body which includes a clamping surface, an opposed securing surface, an edge along which the clamping and the securing surfaces meet, and an aperture which extends through the body between the clamping and the securing surfaces.

The body may be substantially planar and comprising a core and a plurality of anti-rotation projections, each projecting from the core in a plane of the body.

The body may include at least one positioning formation on the clamping surface, adapted to position the clamping element, preventing the clamping element from engaging the clamp head non-concentrically.

The at least one position formation may be a recess formed in the clamping surface, concentric with the aperture and adapted to receive the clamping element.

Alternatively, the body includes a plurality of positioning formations.

Each of the positioning formations may be elevated from the clamping surface, either as a ridge at an edge of each anti-rotation projection, or as projection or button.

The body may include at least one gripping ridge which is elevated from the clamping surface, and which is concentric with the aperture.

The at least one gripping ridge may present an upper surface which is serrated.

The securing surface may be chamfered around the aperture to provide a chamfered recess.

The invention extends to a method of securing an item with a securing assembly, which assembly includes an elongate flexible member which extends between a first end and a second end, a clamp head which has a body which includes a clamping surface and, on an opposed side, a securing surface, and an aperture between the clamping surface and the securing surface, and a clamping element on the flexible member between the clamp body and the second end, the method including the steps of:
(a) feeding the first end of the flexible member through the aperture from the clamping side to the securing side, looping the flexible member around the article, and feeding the free end through the aperture from the securing surface to the clamping surface to create a loop (46) around the article;
(b) pulling on a first end section (48) of the elongate member which emerges from the aperture after creating the loop to close the loop around the article and to draw the clamping element towards the clamp body to clamp the first end section (48) between it and the clamping surface; and
(c) winding the first end section around an edge (28) of the clamp head from the clamping surface to the securing surface, wrapping the first end section around a loop section (50.1) of the loop, and pulling on the first end section from the first end in a direction opposite to the direction of extension of the loop section to pinch the first end section between the loop section and the securing surface (pinched section).

The securing surface may be chamfered around the aperture to provide a chamfered recess and the method may include an additional step (d) of pulling on the first end section from the first end in a direction opposite to the direction of extension of the loop section to pull the pinched section within the chamfered recess in a snap-lock action.

### BRIEF DESCRIPTION OF THE DRAWINGS

The invention is further described by way of examples with reference to the accompanying drawings in which:

FIG. 1 is a view in perspective of a clamp head of a securing assembly in accordance with a first embodiment of the invention;

FIG. 2 is a view in plan of the clamp head of FIG. 1;

FIGS. 3, 4 and 5 diagrammatically illustrate a securing assembly in accordance with the first embodiment of the invention, engaged with an item to be secured;

FIG. 6 is a view in elevation of the securing arrangement;

FIG. 7 is a view in perspective and from below of the securing arrangement, with a twine of the assembly in a first securing configuration;

FIG. 8 is a view in perspective and from above of the securing arrangement, with a twine of the assembly in a second securing configuration;

FIG. 9 is a view in perspective and from above of the securing arrangement, with a twine of the assembly in a third securing configuration;

FIG. 10 is a view in perspective and from above of the securing arrangement, with a twine of the assembly in a fourth securing configuration;

FIG. 11 is a view in plan of a clamp head of a securing assembly in accordance with a second embodiment of the invention;

FIG. 12 is a view in under plan of the clamp head of FIG. 11;

FIG. 13 is a view in perspective and from above of the clamp head;

FIG. 14 is a view in perspective and from below of the clamp head; and

FIG. 15 is a view in perspective and from below of a securing arrangement, in accordance with the second embodiment of the invention, with a twine of the assembly in a first securing configuration.

### DESCRIPTION OF PREFERRED EMBODIMENTS

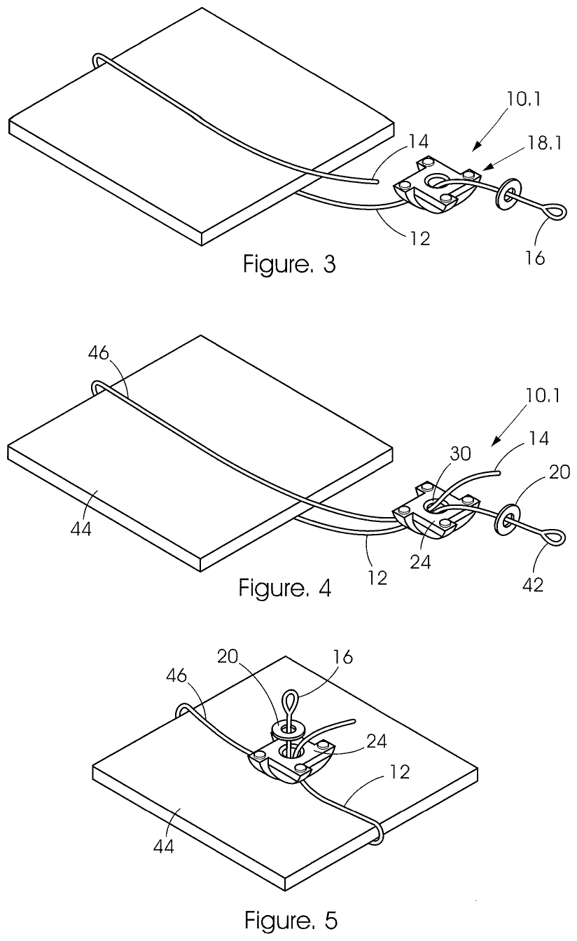

FIGS. 3 to 7 illustrate a securing assembly 10.1 in accordance with a first embodiment of the invention. The securing assembly includes an elongate flexible member 12, such as a length of high tensile rope or twine or the like (hereinafter referred to as “cord”) which extends between a first (free) end 14 and a second (stop) end 16, a clamp head 18.1 engaged with the cord and a clamping element 20 engaged with the cord between the clamp head and the second end.

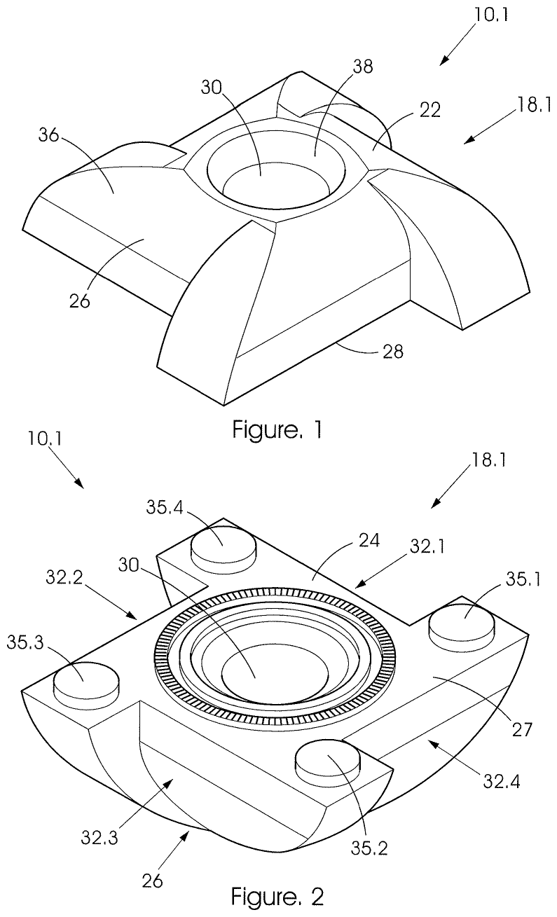

With reference to FIGS. 1 and 2, the clamp head 18.1 has a body 22 which includes a flat clamping surface 24, an opposed securing surface 26, an edge 28 along which the surfaces (24, 26), and a centrally located aperture 30 which penetrates the body, opening at each surface (24, 26). In this example, a core 27 of the body is square in plan, having four sides, respectively designated 32.1, 32.2, 32.3 and 32.4 (see FIG. 2).

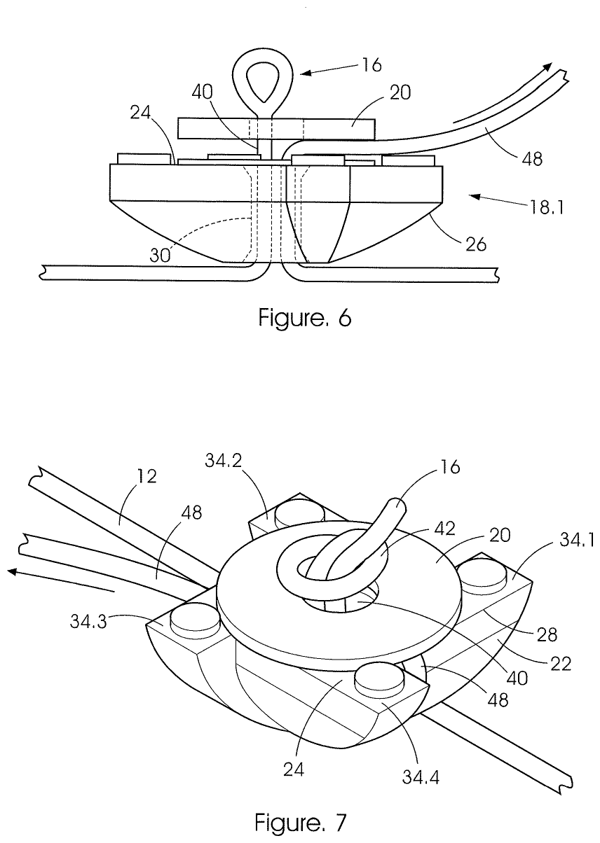

Two concentric gripping rings (respectively designated 33.1 and 33.2) encircle the aperture 30. Each ring is raised from the clamping surface, with a top gripping surface 37 of each ring being flat or flat and serrated. This feature is illustrated in FIGS. 2 and 6. However, merely for ease of illustration, the rings are not illustrated in the other figures illustrating this embodiment.

The body 22 includes four anti-rotation projections, respectively designated 34.1, 34.2, 34.3 and 34.4 (see FIGS. 7 and 9). Each projection extends laterally from a respective side.

Projecting from the clamping surface 24 of each projection 34 is a respective positioning button (respectively designated 35.1, 35.2, 35.3 and 35.4).

Unlike the clamping surface 24, the securing surface of the body 22 has a chamfered surface 36 which extends from a respective side 32 to the aperture 30 where the surface falls into a recessed chamfered opening 38 to the aperture. The chamfered, curved feature of the surface 36 and the opening 38 ensure that there are no sharp edges against which the twine may fray when place in tension as described below. Furthermore, as will be described more fully below, the recessed opening 38 is adapted to receive and to hold an intertwined section of the cord 12.

The clamping element 20, in this example, is a washer. The cord 12 extends through a hole 40 in the washer to secure the washer to the cord.

In a method which is not limiting on the invention, the washer 20 is prevented from moving off the cord by the presence of a knot 42 (see FIG. 7) which is tied into the cord at the stop end 16 and a hollow conical knot cover (not illustrated) into which the knot fits. For ease of illustration, the knot and the cover are only diagrammatically represented as an end loop in the other figures and hereinafter reference to the knot refers to a knot or a knot and a cover combination.

In use of the securing assembly 10.1, reference is made to FIGS. 3 to 9. Securing an item 44 with the securing assembly explained in a number of sequential steps, with reference to the relevant figure.

FIG. 3 illustrates the cord 12 looped around the item 44, with a free end 14 about to be feed through the aperture 30 of the clamping head body 22 from a “securing surface” side to a “clamping surface” side. As illustrated in FIG. 4, once the free end is feed through, a loop 46 is completed around the item.

By pulling on the free end 14, the washer 20 is drawn, and then pulled by the knot 42, towards and into engagement with the clamping surface 24 of the clamp head 18.

As illustrated in FIGS. 5 and 6, the effect of this pulling action is to tighten the loop 46 around the item 44 and, to hold the tension in the tightened loop, to bring the washer 20 into contact with a free end section 48 of the cord 12, clamping this section between it and, initially the gripping surface 37, and thereafter, the gripping surface and the clamping surface 24.

The washer is centralised relatively to the aperture 30 and the gripping rings 33, to optimise the clamping function of the washer, by the positioning buttons 35 which prevent the washer from engaging in a substantially de-centric configuration.

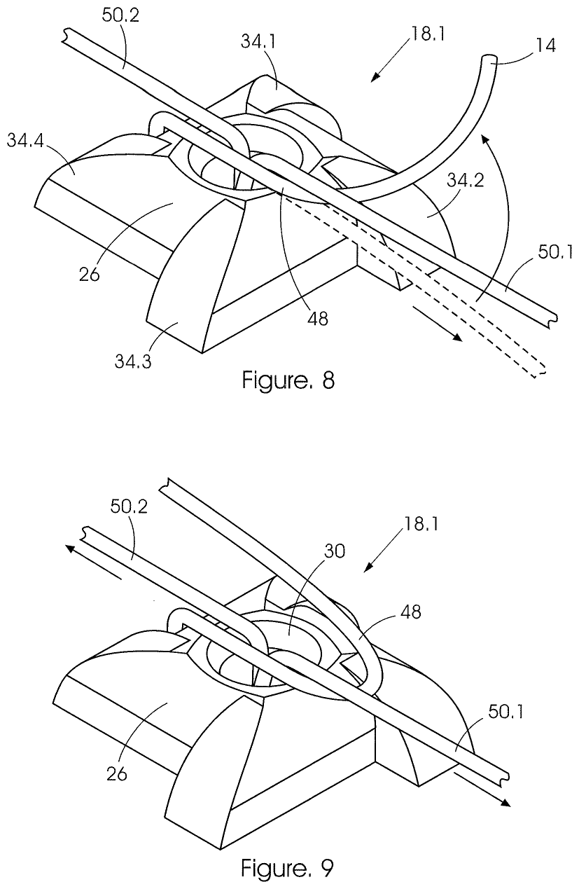

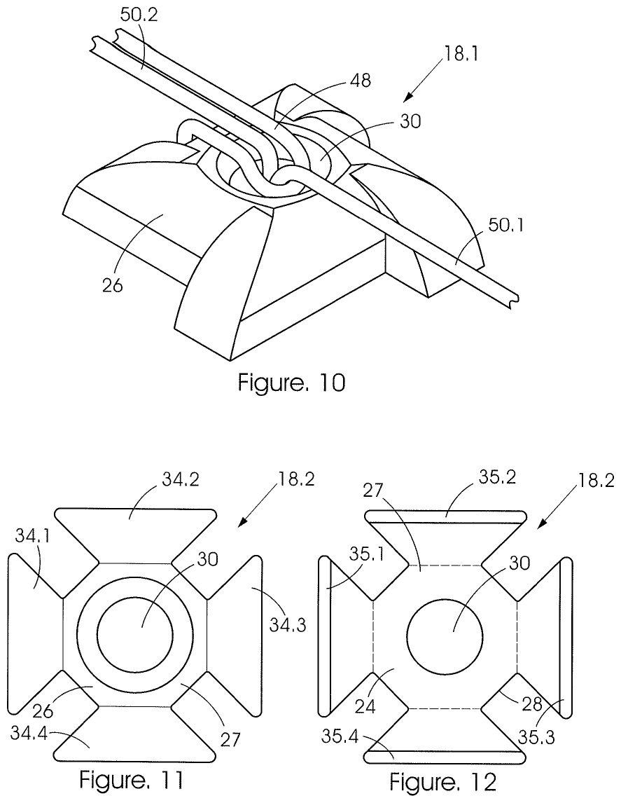

Once the tightened loop 44 is held around the item 44, the free end section 48 needs to be secured to ensure that the washer does not disengage. This is done, as illustrated in FIGS. 7 and 8, by pulling the free end section 48 beneath the clamp head, around the edge 28, from the clamping surface 24 to the securing surface 26.

With reference to FIG. 8, the free end section 48 is then feed beneath a first loop section 50.1, and then pulled (see direction arrow) in a direction of a second loop section 50.2, increasing the tension in the loop 46 (and therefore the first and the second loop sections 50.1 and 50.2 which impose opposed forces on the clamp head 18) and jamming the free end section 48 between the first twine section and the securing surface 26.

As illustrated, the free end section 48 abuts an anti-rotation projection 34.4. This projection ensures that the cord does not slide off the clamp head 18 when the loop 46 is tensioned and that the clamp head does not rotate under torque created by any uneven imposition of the opposed forces (illustrated with directional arrows in FIG. 9) on the clamp head 18.

In a final step, with a further tug on the free end in a direction of the second loop section 50.2, the free end section which wraps around the first loop section (designated 52) is pulled into the confines of the recessed opening 38 in a snap lock action. The section 52 is prevented disengaging from the recessed opening by the overlying first loop section which is under high tensile forces.

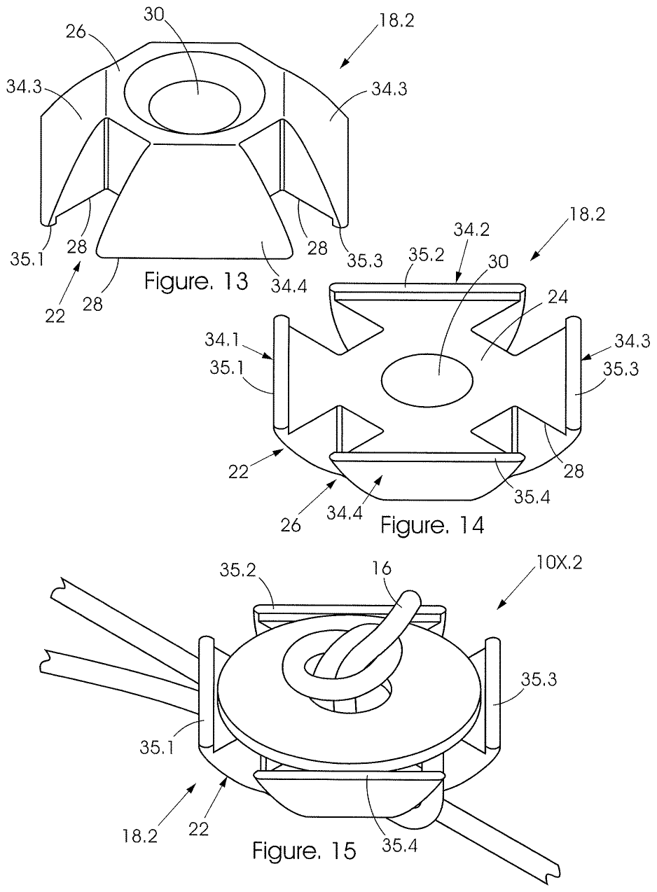

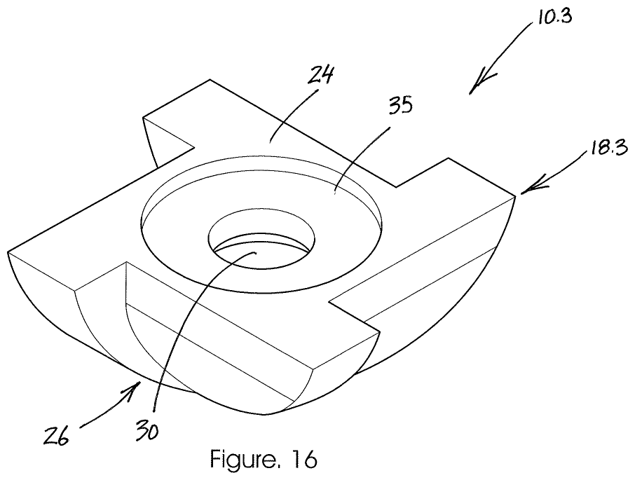

A second embodiment of the invention, a securing assembly 10.2, is illustrated in FIGS. 11 to 15. In describing this embodiment, like features bear like designations.

This embodiment functions in much the same way as the earlier embodiment 10.1. However, this embodiment does differ structurally in that the body 18.2 has a hexagonal core 27 from which four anti-rotation projections (34.1, 34.2, 34.3 and 34.4) project in four perpendicular directions.

Each of the projections has a sloping securing surface 26 which ends at the edge 28.

The clamping surface 26 is flat across the core and the projections and is bordered at an edge (28) of each projection by a respective positioning ridge (35.1, 35.2, 35.3 and 35.4). The ridges are functionally analogous to the positioning buttons of the first embodiment (10.1). Each ridge is elevated from the clamping surface.

The clamping surface, bordered by the ridges, provides a recessed space into which the washer 20 can fit in concentrically relatively to the aperture.

A securing assembly 10.3, in accordance with a third embodiment of the invention, is illustrated in FIG. 16.

This embodiment is the same as the first embodiment in all respects with the exception of the location and configuration of the positioning formations. In this embodiment, there is a single position formation, a circular recess 35, which is formed into the clamping surface 24 in a position concentric to the aperture 30. The dimensions of the circular recess are complementary to accommodate receipt of washer 20.

1. A securing assembly (10.1, 10.2) which includes:
an elongate flexible member (12) which extends between a first end (14) and a second end (16),
a clamp head (18.1, 18.2) which has a body (22) which includes a clamping surface (24) and, on an opposed side, a securing surface (26), and an aperture (30) which extends through the body between the clamping surface and the securing surface, and
a clamping element (20),
wherein the flexible member engages the body by passage through the aperture to provide a loop (46) on a side of the securing surface, with the first and second ends on a side of the clamping surface, and
wherein the clamping element engages the flexible member between the clamping surface and the second end.

2. A securing assembly according to claim 1 wherein the body is substantially planar.

3. A securing assembly according to claim 2 wherein the body comprises a core (27) and a plurality of anti-rotation projections (34), each projecting from the core in a plane of the body.

4. A securing assembly according to claim 3 wherein the body includes at least one positioning formation (35) on the clamping surface, adapted to position the clamping element, preventing the clamping element from engaging the clamp head non-concentrically.

5. A securing assembly according to claim 1 wherein the body includes at least one gripping ridge (33) which is elevated from the clamping surface, and which is concentric with the aperture.

6. A securing assembly according to claim 4 wherein the at least one gripping ridge presents an upper surface (37) which is serrated.

7. A securing assembly according to claim 1 wherein the securing surface is chamfered around the aperture to provide a chamfered recess (36).

8. A securing assembly according claims claim 1 wherein the clamping element is a circular disc.

9. A securing assembly according to claim 1 wherein the elongate member has a stop formation (42) positioned at or proximate to the second end.

10. A securing assembly kit which includes:
an elongate flexible member (12) which extends between a first end (14) and a second end (16),
a clamp head (18.1, 18.2) which has a body (22) which includes a clamping surface (24) and, on an opposed side, a securing surface (26), and an aperture (30) which extends through the body between the clamping surface and the securing surface, and which is adapted to receive passage of the elongate flexible member, and
a clamping element (20) which is adapted to engage the elongate flexible member.

11. A securing assembly kit according to claim 10 wherein the body is substantially planar and comprises a core (27) and a plurality of anti-rotation projections (34), which project from the core in a plane of the body.

12. A securing assembly kit according to claim 11 wherein the body includes at least one positioning formation (35) on the clamping surface, adapted to position the clamping element, preventing the clamping element from engaging the clamp head non-concentrically.

13. A securing assembly according to claim 10 wherein the body includes at least one gripping ridge (33) which is elevated from the clamping surface, and which is concentric with the aperture.

14. A securing assembly according to claim 13 wherein the at least one gripping ridge presents an upper surface (37) which is serrated.

15. A securing assembly according to claim 10 wherein the securing surface is chamfered around the aperture to provide a chamfered recess (36).

16. A securing assembly according to claim 10 wherein the clamping formation is a circular disc which has a hole sized to receive passage of the elongate flexible member.

17. A securing assembly according to claim 10 wherein the elongate element has a stop formation (42) positioned at or proximate to the second end.

18. A clamping device (18.1, 118.2) for a securing assembly (10.1, 10.2) comprising a clamp body (22) which includes a clamping surface (24), an opposed securing surface (26), an edge (28) along which the clamping and the securing surfaces meet, and an aperture (30) which extends through the clamp body between the clamping and the securing surfaces.

19. A clamping device according to claim 18 wherein the clamp body is substantially planar and comprises a core (27) and a plurality of anti-rotation projections (34), each projecting from the core in a plane of the body.

20. A clamping device according to claim 19 wherein each anti-rotation projection includes a positioning formation (35) which is elevated from the clamping surface of the respective projection.

21. A clamping device according to claim 18 wherein the body includes at least one gripping ridge (33) which is elevated from the clamping surface, and which is concentric with the aperture.

22. A clamping device according to claim 21 wherein the at least one gripping ridge presents an upper surface (37) which is serrated.

23. A clamping device according to claim 18 wherein the securing surface is chamfered around the aperture to provide a chamfered recess (38).

24. A method of securing an article (44) with a securing assembly (10.1, 10.2), which assembly includes an elongate flexible member (12) which extends between a first end (14) and a second end (16), a clamp head (18) which has a clamp body (22) which includes a clamping surface (24) and, on an opposed side, a securing surface (26), and an aperture (30) between the clamping surface and the securing surface, and a clamping element (20) on the flexible member between the clamp body and the second end, the method including the steps of:
(a) feeding the first end of the flexible member through the aperture from the clamping side to the securing side, looping the flexible member around the article, and feeding the free end through the aperture from the securing surface to the clamping surface to create a loop (46) around the article;
(b) pulling on a first end section (48) of the elongate member which emerges from the aperture after creating the loop to close the loop around the article and to draw the clamping element towards the clamp body to clamp the first end section (48) between it and the clamping surface; and
(c) winding the first end section around an edge (28) of the clamp head from the clamping surface to the securing surface, wrapping the first end section around a loop section (50.1) of the loop, and pulling on the first end section from the first end in a direction opposite to the direction of extension of the loop section to pinch the first end section between the loop section and the securing surface.
